(19) United States
(12) Patent Application Publication
(10) Pub. No.: US 2004/0239655 A1
(43) Pub. Date: Dec. 2, 2004

(54) Display drive control system

(76) Inventors: Kunihiko Tani, Kodaira (JP); Takayuki Nakaji, Tachikawa (JP); Kazuhisa Higuchi, Tachikawa (JP); Yasushi Nagata, Higashimurayama (JP)

Correspondence Address: MILES & STOCKBRIDGE PC, 1751 PINNACLE DRIVE, SUITE 500, MCLEAN, VA, 22102-3833, US

(21) Appl. No.: 10/493,696

(22) PCT Filed: Dec. 27, 2001
(86) PCT No.: PCT/JP01/11548

(51) Int. Cl. G09G 5/00

(52) U.S. Cl. 345/204

(57) ABSTRACT

A voltage level shift circuit is provided on a power IC manufactured with a high-voltage process instead of on a source driver IC with a large capacity display memory manufactured with a low-voltage fine wiring process. This makes it possible to reduce the cost of manufacturing a source driver IC and decrease the chip area, leading to reduction in the overall IC chip cost.

### BACKGROUND OF THE INVENTION

The present invention relates to display drive control in a display unit and more particularly to a display drive control system which controls image data display in a liquid crystal display unit, organic EL (electroluminescence) display unit or another type of matrix display unit.

Usually, a matrix display unit has a display panel which consists of a two-dimensional matrix where scanning signal lines are arranged in parallel in one direction on a substrate and many image signal lines arranged in parallel in a way to cross the scanning signal lines, with a picture element at each intersection of signal lines.

It also has a display control circuit which supplies scanning signals and image signals to this display panel to display an image. Display units of this type include liquid crystal display units, organic EL display units, plasma display units, and field emission display units.

The display panel drive control circuit has: a scanning signal line driver circuit which selectively drives scanning signal lines; an image signal line driver circuit which supplies image signals to image signal lines; and a power circuit which supplies various voltage signals to the driver circuits and display panel and applies operating power.

The display panels of these display units are almost identical in their drive control circuit structure for pixel selection except the matrix display panel structure. Therefore, an active matrix LCD panel for a mobile phone will be explained next as a typical display panel which uses thin film transistors as pixel selection elements (switching elements).

In response to demand for smaller mobile phones, a recent growing trend is that drivers as components of a display unit are packaged on an IC chip to decrease the number of components. An LCD panel of an active matrix display unit has active elements (thin film transistors or the like) at intersections of scanning signal lines and image signal lines. An image is displayed when these active elements are turned on and off.

An LCD panel which uses thin film transistors as active elements for pixel selection has gate electrodes as scanning signal electrodes for input of scanning signals into the thin film transistors and source or drain electrodes (here assumed as source electrodes) as image signal electrodes for input of image signals.

In an LCD unit which uses this type of LCD panel, a timing signal generation circuit which generates voltages or timing signals to be given to a scanning line driver circuit (gate driver) for driving scanning signal lines (gate lines) connected with scanning electrodes for thin film transistors, and a voltage level shift circuit which shifts the generated timing signals to predetermined levels of voltages are mounted on a chip together with an image signal line driver circuit (source driver) which controls image signal lines (source lines or drain lines, here assumed as source lines) connected with image signal electrodes. With the increasing tendency for higher resolution display, the source driver IC is becoming more sophisticated and the drive voltage is becoming lower.

A gate driver in an LCD panel includes a shift register which gives selection signals to gate lines. A source driver in an LCD panel incorporates: a display signal generation circuit which generates signals suitable for LCD panel display according to image data from a host computer as a display signal source; a circuit which generates various timing signals; and a level shift circuit which generates gate driver control signals (frame pulse, line clock, shift clock, etc) to be given to the gate driver.

The source driver is an IC with a large-capacity display memory (RAM) for storage of display data in the form of a chip mounted on a display panel substrate. This chip is manufactured, for example, with a 0.35 μm fine CMOS process.

The voltage level of frame pulse, line clock and shift clock as gate driver control signals (for instance, ±10V−±12V) is much higher than that of image signals (source signals, for example 3V). The timing signal generation circuit is more complicated than the level shift circuit. When the voltage level shift circuit (high voltage) is integrated with the source driver IC (low voltage), the chip size (mounting area) must be larger, resulting in a higher cost.

### SUMMARY OF THE INVENTION

An object of the present invention is to provide a low cost display drive control system, particularly with an IC source driver, by separation of the source driver manufactured with a sophisticated process from a voltage level shift circuit manufactured with a less sophisticated process.

According to the present invention, a display drive control system has a voltage level shift circuit for gate driver control signals on the side of a power IC provided separately from a source driver IC. This means that the source driver IC only has low-voltage-driven fine circuitry, leading to easy design and cost reduction in production of a display drive control system with an IC source driver. Typical embodiments of the present invention as matrix display units are outlined below.

According to one aspect of the present invention, a display unit has a display panel with an active matrix of pixels and scanning signal lines and image signal lines for selecting the pixels, a driver circuit as a first IC for selecting individual pixels of the display panel, and a power circuit as a second IC for supplying operating voltage to the display panel and the driver circuit.

The driver circuit comprises a scanning line driver circuit which supplies scanning signals to the scanning signal lines and an image signal line driver circuit which supplies image signals to the image signal lines.

The image signal line driver circuit includes a timing signal generator which generates timing signals to control display timings for the display panel.

The power circuit has a scanning line control signal voltage level shift circuit which shifts the voltage level of timing signals generated by the timing signal generator and applies resulting voltage to the scanning line driver circuit.

According to another aspect of the invention, the signal line driver circuit and the timing signal generator are mounted on an IC chip to make up a signal line driver control circuit chip and the power circuit and the voltage level shift circuit are mounted on an IC chip to make up a power control circuit chip. The power control circuit chip receives timing signals generated by the timing signal generator provided with the image signal line driver circuit and shifts the voltage level to a level required to drive the scanning lines of the display panel.

This constitution makes it possible that timing signals are generated on the same IC chip (manufactured with a sophisticated fine process) on which the signal line driver circuit lies and voltage level shifting is done on the same IC chip (manufactured with a high voltage process) on which the power circuit lies. Hence, the cost of the IC chips can be reduced without diminishing the advantages of the chips.

Also, when the timing signal generator is included in the power circuit, the number of signal lines between the image signal line driver circuit and the power circuit is decreased.

Like the image signal driver circuit, the scanning line driver circuit may be mounted, in the form of an IC chip, on the display panel substrate. The scanning line driver circuit may also be directly formed on the display panel substrate together with active elements for pixel selection, as an internal circuit, in order to simplify the display unit structure.

### BRIEF DESCRIPTION OF THE DRAWINGS

FIG. 1 is a block diagram showing the structure of a display drive control system according to an embodiment of the present invention;

FIG. 2 shows an LCD panel interface configuration which characterizes a display drive control system according to an embodiment of the present invention;

FIG. 3 is a waveform chart illustrating an example of operation timings in the display drive control system shown in FIG. 2;

FIG. 4 is a waveform chart illustrating an example of operation timings in the display drive control system shown in FIG. 2;

FIG. 5 is a schematic diagram illustrating the structure of a low-voltage MOS transistor used in source driver IC chip circuitry according to the present invention;

FIG. 6 is a schematic diagram illustrating the structure of a high-voltage MOS transistor used in power IC chip circuitry according to the present invention;

FIG. 7 is a circuit diagram showing a first level shifter LS1 as a component of a level shift circuit;

FIG. 8 is a circuit diagram showing a second level shifter LS2 as a component of a level shift circuit;

FIG. 9 is a circuit diagram showing a third level shifter LS3 as a component of a level shift circuit;

FIG. 10 is a waveform chart illustrating voltage level shifting by a level shift circuit;

FIG. 11 shows an LCD panel interface configuration which characterizes a display drive control system according to another embodiment of the present invention;

FIG. 12 is a circuit diagram showing the structure of a gate driver incorporated in a display panel which constitutes a display drive control system according to the present invention; and

FIG. 13 is a schematic diagram illustrating the overall structure of a display unit which uses a display drive control system according to the present invention.

### DETAILED DESCRIPTION OF THE PREFERRED EMBODIMENTS

Next, LCD units according to preferred embodiments of the present invention will be described in detail with reference to the accompanying drawings.

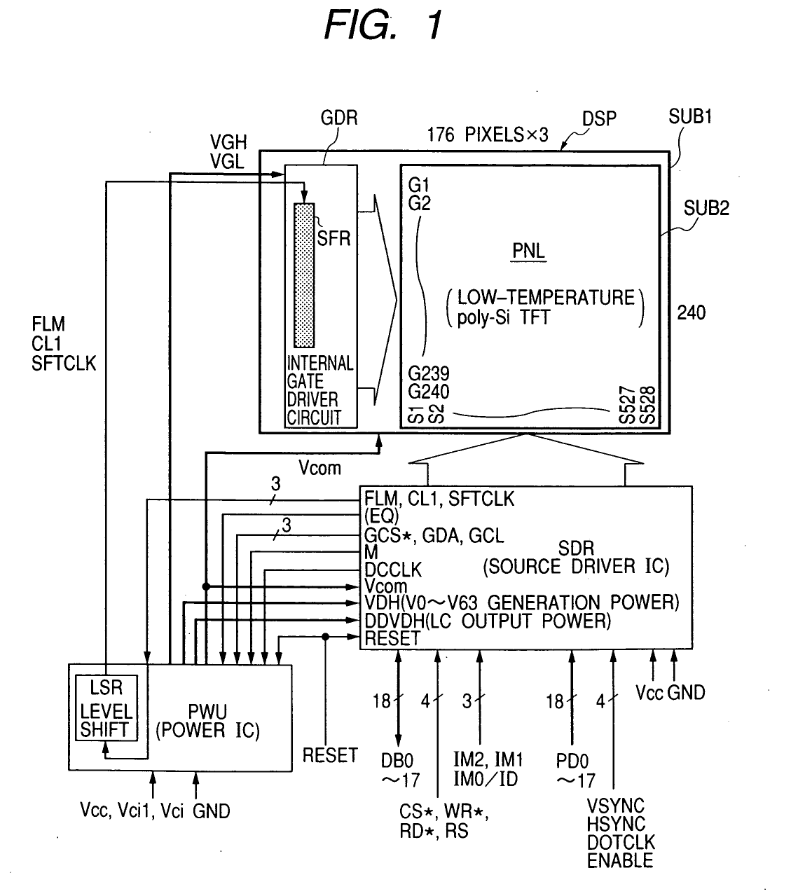

FIG. 1 shows the structure of a display drive control system according to an embodiment of the present invention. In this embodiment, a display panel DSP has an LCD panel PNL which permits color display of (176×3) pixels×240 lines where low-temperature polysilicon thin film transistors TFT (low-temperature poly-Si TFT in FIG. 1) are used as active elements.

On the LCD panel PNL, G1, G2 . . . G239, G240 represent gate lines and S1, S2 . . . S527, S528 represent source lines.

The LCD panel PNL has a liquid crystal layer between two substrates SUB1 and SUB2. The substrate SUB1 bearing thin film transistors TFT incorporates a gate driver GDR. The gate driver GDR is formed together with thin film transistors as pixels on the gate lines of the LCD panel PNL through a process. This gate driver GDR has a shift register SFR to send line selection signals to the gate lines of the LCD panel PNL one after another.

A source driver (source driver IC in FIG. 1) which supplies image signals to source lines of the LCD panel PNL generates image signals according to image signals and various timing signals from a host computer and voltages. The source driver SDR is formed on a semiconductor substrate (chip) of monocrystal like silicon with a known CMOS process.

As signals coming into the source driver SDR from the host computer, VSYNC represents a vertical synchronous signal (image signal); HSYNC a horizontal synchronous signal; DOTCLK a dot clock; and ENABLE an enable signal. In the figure, PD0 to PD17 denote image signals; IM2, IM1 and IM0/ID denote signals used to specify the mode of interfacing with the host computer (not shown) or set a device ID; CS*, WR*, RD* and RS denote chip select, write, read and register select signals respectively; DB0 to DB17 data buses; and RESET denotes a reset signal. Vcc (main power voltage) and GND (grounding voltage) show reference operating voltages for thin film transistors TFT, shift registers and the like.

The power IC chip PWU generates common electrode power V com, liquid crystal output power DDVDH, tone voltage (V0-V63) generation power VDH, gate driver GDR operating voltages VGH and VGL which are required for the LCD panel PNL, source driver IC, and gate driver GDR. The power IC chip PWU is formed on a semiconductor substrate of monocrystal like silicon with a known CMOS process.

The source driver IC chip SDR generates tone voltages (V0-V63) in response to image signals PD00 to PD17 and supplies them to source lines of the LCD panel PNL.

The power IC chip PWU has a level shift circuit LSR in addition to the function of generating various supply voltages as mentioned above. The level shift circuit LSR shifts the frame pulse FLM, line clock CL1, shift clock SFTCLK which are generated by the source driver IC, to the gate driver GDR control voltage level.

MOS logic voltages Vcc, Vcil, Vci, and GND are supplied from the host computer to the power IC chip PWU.

The general operation of the LCD system is known and an explanation will be given only of what is unique to the present invention.

The source driver SDR supplies image signals to source lines of the LCD panel PNL according to image signals and timing signals from the host computer and supply voltages.

In the power IC chip PWU, the level shift circuit LSR shifts not only voltages generated by the IC chip itself but also the frame pulse FLM, line clock CL1, shift clock SFTCLK generated by the source driver SDR, to a control voltage level for the gate driver GDR.

The LCD panel may be an amorphous silicon thin film transistor panel or a low-temperature polysilicon thin film transistor panel. The voltages of the gate driver GDR control signals (frame pulse FLM, line clock CL1, shift clock SFTCLK, etc.) are almost within the range from ±10V to ±12V.

Since the source driver SDR has to incorporate a large capacity memory for display, wires should be fine for the sake of cost advantage. However, high voltage is not suitable for the fine wiring process used for the manufacture of the source driver SDR. Therefore, if a high-voltage level shift circuit should be mounted on the source driver SDR, the cost advantage would not be achieved.

In this embodiment, the level shift circuit LSR is mounted on the power IC chip PWU. The level shift circuit LSR is manufactured with the same process as the power IC chip PWU. In the conventional method where the high-voltage level shift circuit LSR is mounted on the source driver IC chip SDR manufactured with a fine wiring process, there have been a difficulty in the manufacturing process and a restraining factor for cost reduction as mentioned above.

On the other hand, in this embodiment, the level shift circuit LSR is mounted on the high-voltage power IC chip PWU manufactured with an equivalent process and the source driver IC generates gate driver GDR control signals (frame pulse FLM, line clock CL1, shift clock SFTCLK, etc.) at a normal logic voltage level and the level shift circuit LSR provided on the power IC chip PWU shifts the voltages to a required level and sends them to the gate driver GDR.

This makes it possible to manufacture the source driver IC by a fine wiring process and reduce cost without affecting the chip size and diminishing the advantages as an IC chip.

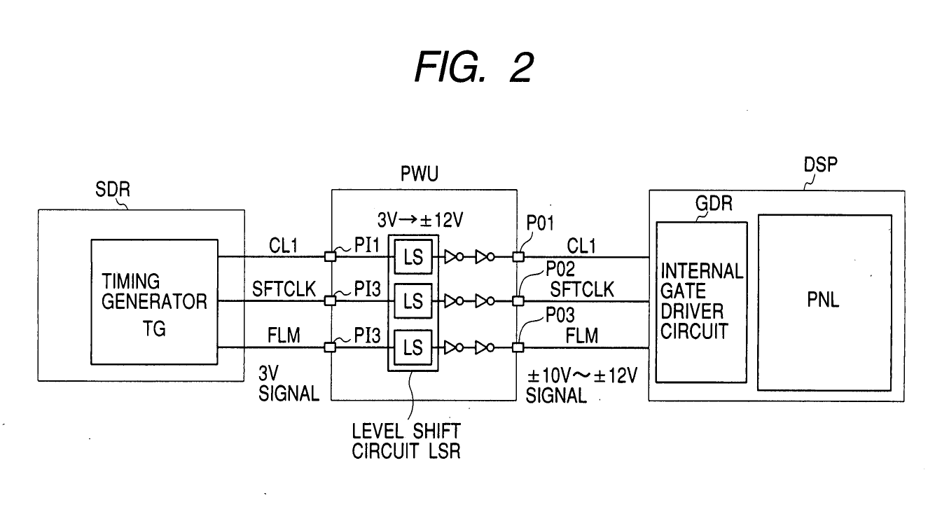

FIG. 2 shows the interface configuration of an LCD panel which characterizes a display drive control system according to an embodiment of the present invention. In the source driver SDR, the timing generator TG generates timing signals (line clock CL1, shift clock SFTCLK, frame pulse FLM).

Here, the voltage of these timing signals is assumed to be 3V. These timing signals are sent to the level shift circuit LSR provided on the power IC chip PWU where level shifters LS1, LS2, and LS3 shift the voltages to a level within the range of ±10 V to ±12 V.

The power IC chip PWU has input ports PI1, PI2, and PI3 and output ports PO1, PO2, and PO3. The input ports receive low voltage timing signals (line clock CL1, shift clock SFTCLK, frame pulse FLM) from the source driver SDR and the output ports sends the level-shifted high voltage timing signals (line clock CL1, shift clock SFTCLK, frame pulse FLM) to the gate driver circuit GDR.

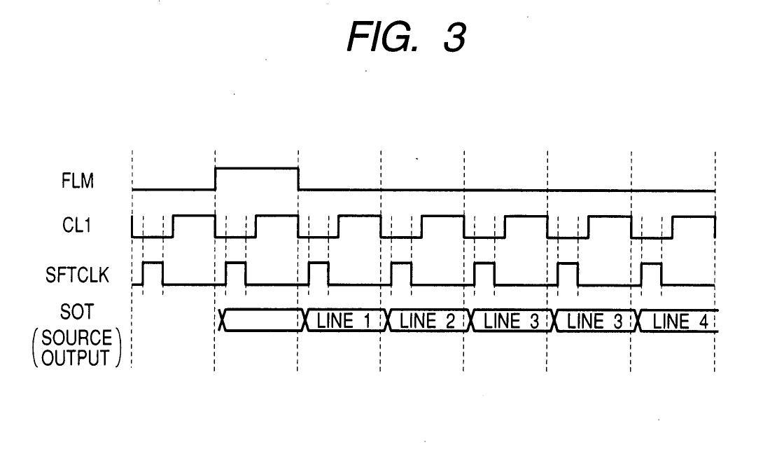

FIG. 3 is a waveform chart which illustrates operation timings of the display drive control system shown in FIG. 2. This operation sequence concerns display of a monochrome image. Referring to FIG. 3, waveforms FLM, CL1 and SFTCLK are waveforms of timing signals (line clock CL1, shift clock SFTCLK, frame pulse FLM) which are respectively supplied to the gate driver GDR from the output ports PO1, PO2, and PO3 of the power IC chip PWU shown in FIG. 2.

In the chart, SOT represents a source output (image signal) which is sent from the source driver SDR to the LCD panel PNL (see FIG. 1).

An image appears on the LCD panel PNL according to the image signal as follows. Line clock CL1 synchronizes with the trailing edge of frame pulse FLM and shift clock SFTCLK is generated synchronously with the trailing edge of line clock CL1. A first gate line (Line 1) is selected by this shift clock SFTCLK and image signal SOT (source output) is supplied to the source line of a thin film transistor connected with the selected gate line.

In this way, image signal SOT is applied to pixels of selected thin film transistors to display one line of image. This sequence is continued for gate lines sequentially selected by shift clock SFTCLK so that a two-dimensional image appears on the LCD panel PNL.

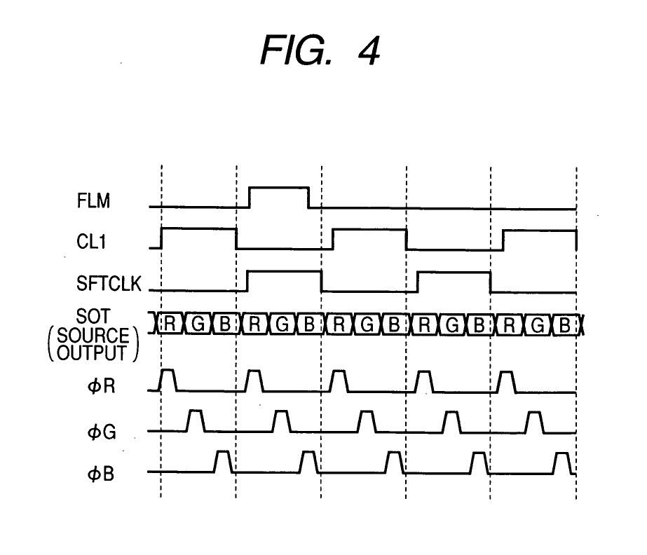

FIG. 4 is a waveform chart which illustrates operation timings of the display drive control system shown in FIG. 2. In FIG. 4, waveforms φR, φG, and φB respectively represent R (red), G (green), and B (blue) select signals and waveforms FLM, CL1, SFTCLK and SOT are the same as those in FIG. 3.

In this example, while Line 1 is selected, R, G, and B color image signals are sent, on a time division basis, from the source driver SDR to source lines of thin film transistors which constitute R, G, and B pixels of the LCD panel PNL. The rest of the sequence is the same as in FIG. 3.

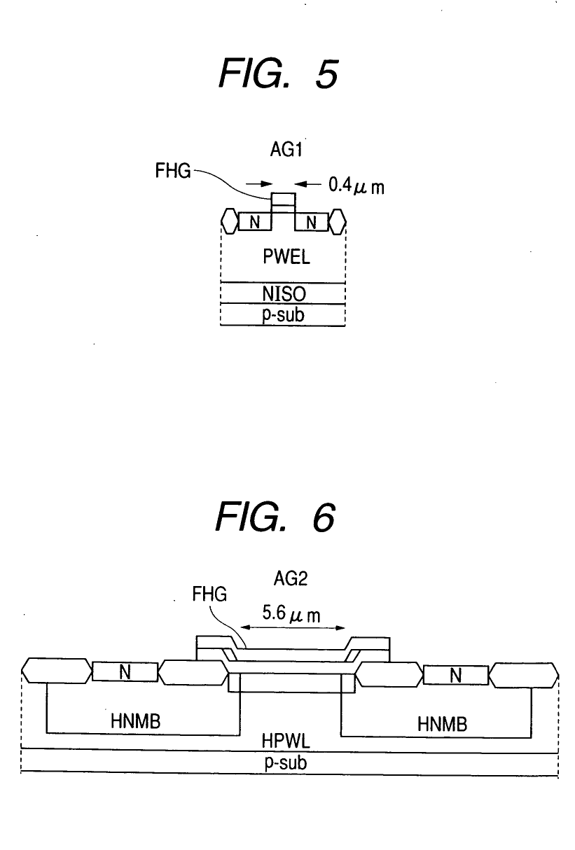

FIG. 5 schematically shows the structure of a low-voltage MOS transistor which is used in the circuit of the source driver IC chip according to the present invention. In this low-voltage MOS transistor, an N-type well NISO overlies a P-type silicon substrate p-sub and a P-type well PWELL overlies NISO, with N-type silicon layer N over PWELL and gate FHG at the top. In this low-voltage MOS transistor, the dimension AG1 of the gate FHG is 0.4 μm.

FIG. 6 schematically shows the structure of a high-voltage MOS transistor used in the power IC chip according to the present invention. This high-voltage MOS transistor consists of a P-type well HPWL over a P-type silicon substrate p-sub, NHMB, N-type silicon layer N and gate FHG. The dimension AG2 of the gate FHG is 5.6 μm.

As apparent by comparison of FIGS. 5 and 6, the FHG gate dimension AG1 is largely different from the gate FHG dimension AG2. The dimension AG2 of the high-voltage MOS transistor is more than ten times larger than the dimension AG1 of the low voltage MOS transistor. Therefore, obviously the chip size of the high-voltage MOS transistor should be much larger than that of the low-voltage MOS transistor. From this, it can be understood that, as stated above, it is disadvantageous to mount the level shift circuit on the source driver IC chip.

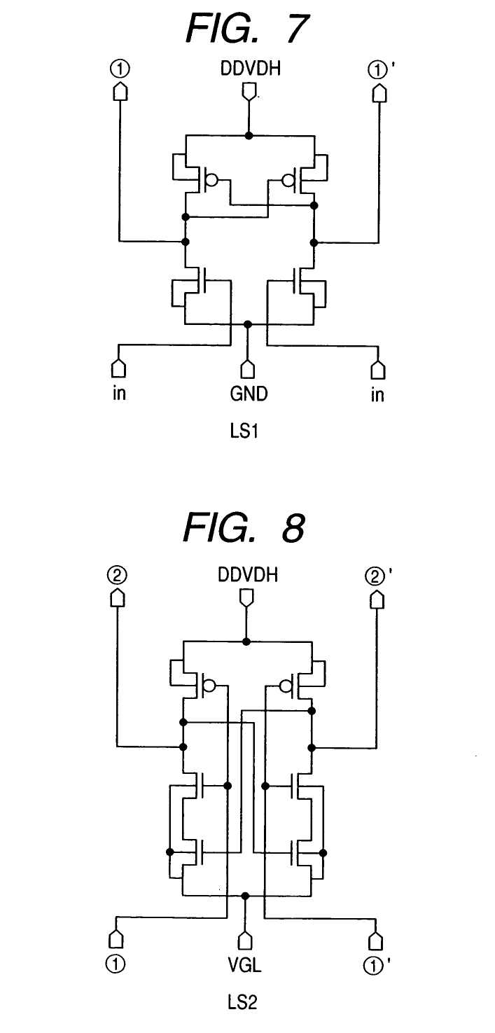

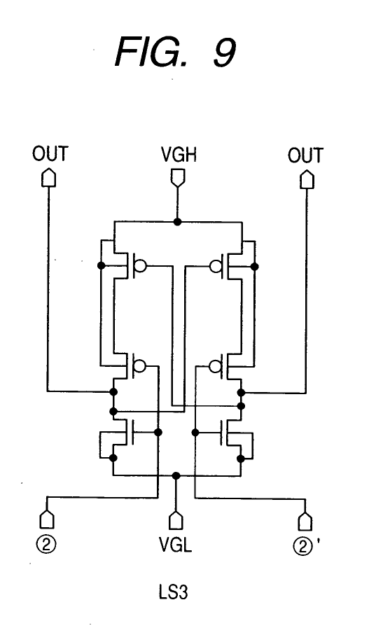

FIGS. 7, 8 and 9 are circuit diagrams which show the structures of various level shifters of the voltage level shift circuit mounted on the power IC chip. The level shift circuit consists of three level shifters LS1, LS2, and LS3. A pair of input terminals in FIG. 7 correspond to the input ports PI1, PI2, and PI3 of the power IC chip PWU in FIG. 2; and a pair of output terminals out in FIG. 9 correspond to the output ports PO1, PO2, and PO3 in FIG. 2.

FIG. 7 shows the circuit of a first level shifter LS1 which shifts the level of the signal between MOS logic voltage Vcc and grounding voltage GND to the level of the signal between liquid crystal output voltage DDVDH and grounding voltage GND.

FIG. 8 shows the circuit of a second level shifter LS2 which shifts the level of the signal between liquid crystal output voltage DDVDH and grounding voltage GND to the level of the signal between liquid crystal output voltage DDVDH and gate driver voltage VGL.

FIG. 9 shows the circuit of a third level shifter LS3 which shifts the level of the signal between liquid crystal output voltage DDVDH and gate driver voltage VGL to the level of the signal between gate driver voltage VGH and gate driver voltage VGL.

Output terminals (1) and (1)′ in FIG. 7 are connected with input terminals (1) and (1)′ in FIG. 8 and output terminals (2) and (2)′ in FIG. 8 are connected with input terminals (3) and (3)′ in FIG. 9.

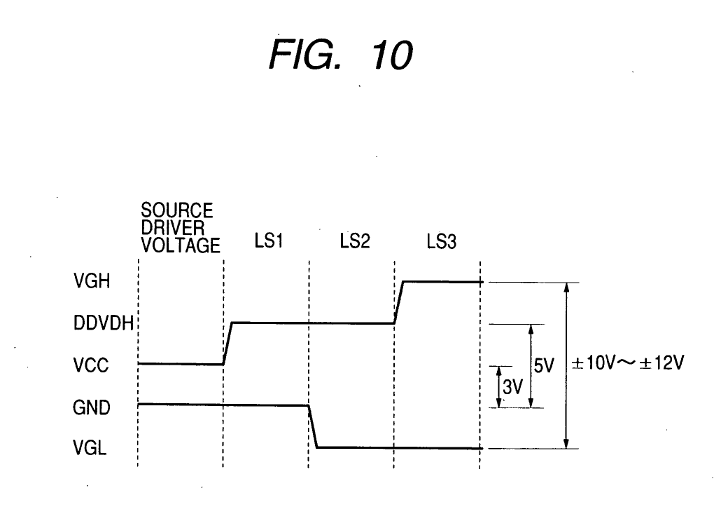

FIG. 10 is a waveform chart which illustrates voltage level shifting by the level shift circuit. As a signal passes through the first level shifter LS1, second level shifter LS2, and third level shifter LS3, the level of the signal between MOS logic voltage Vcc and grounding voltage GND is shifted to the level of the signal between gate driver voltage VGH and gate driver voltage VGL through the sequence shown here.

As shown in FIG. 10, 3V signals (low voltage line clock CL1, shift clock SFTCLK, frame pulse FLM) which enter the pair of input terminals in from the source driver SDR become 5V signals at the first level shifter LS1 and then enter the second level shifter LS2.

The 5V signals which have entered the second level shifter LS2 become ±10 V to ±12 V signals (high voltage line clock CL1, shift clock SFTCLK, frame pulse FLM) which in turn go through the pair of output terminals outn to the gate driver GDR of the LCD panel PNL.

In the above embodiment, all 3V signals (low voltage line clock CL1, shift clock SFTCLK, frame pulse FLM) are generated by the timing generator TG provided on the source driver SDR and supplied to the power IC chip PWU. However, the present invention is not limited thereto and may be embodied in a form explained below.

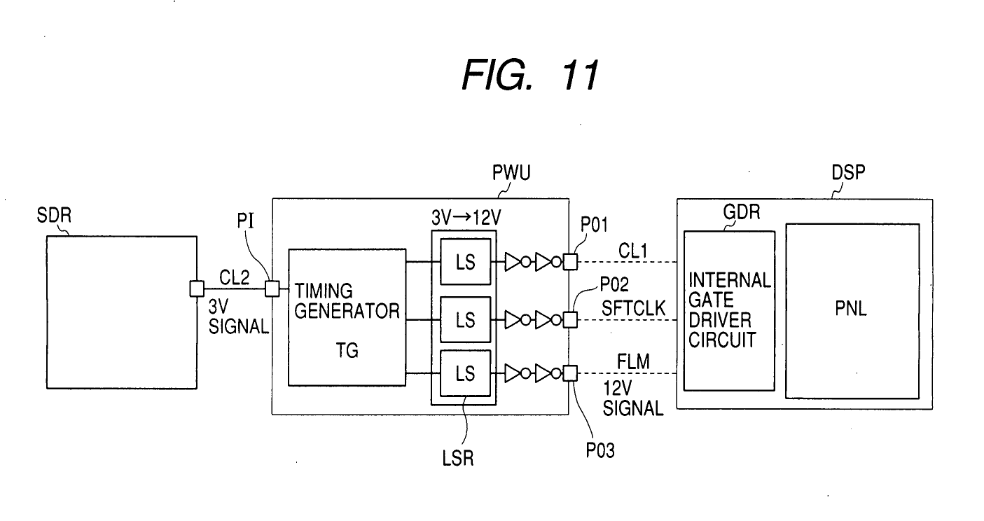

FIG. 11 shows the interface configuration of an LCD panel which characterizes a display drive control system according to another embodiment of the present invention. In this embodiment, the timing generator TG is located on the power IC chip PWU.

The timing generator TG on the power IC chip PWU generates low-voltage line clock CL1, shift clock SFTCLK and frame pulse FLM according to dot clock CL2 from the source driver SDR and these signals are level-shifted by the level shift circuit LSR to become high-voltage line clock CL1, shift clock SFTCLK and frame pulse FLM.

The input port of the power IC chip PWU also servers as an input port PI for dot clock CL2. Voltage level shifting by the level shift circuit is the same as shown in FIG. 10.

The configuration of the display drive control system according to this embodiment is the same as shown in FIG. 1 except that the signal line for transmission of low-voltage line clock CL1, shift clock SFTCLK and frame pulse FLM is removed.

Therefore, in this embodiment, the number of wires between the source driver SDR and the power IC chip PWU is decreased, which provides more room for wiring on the LCD panel substrate and also reduces the overall cost.

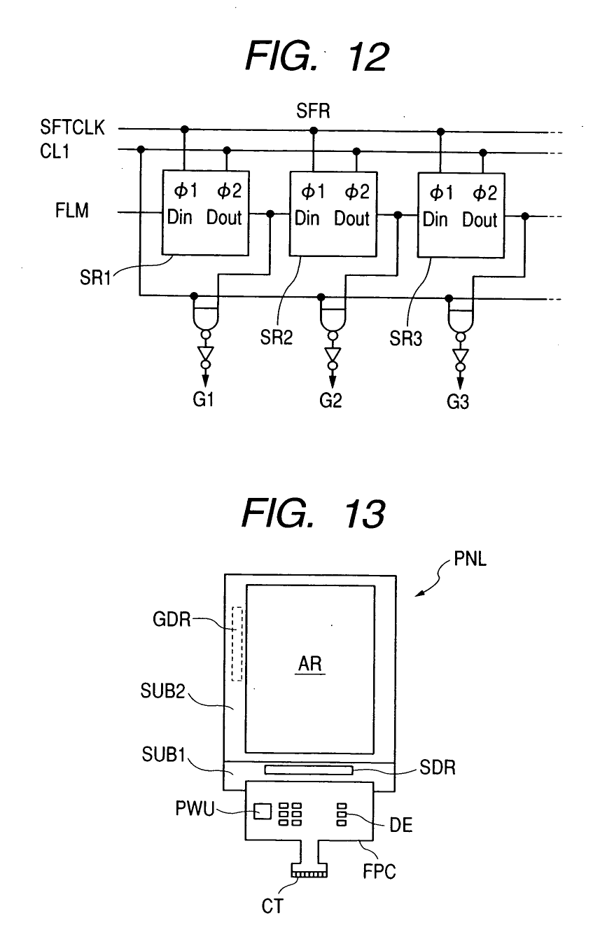

FIG. 12 is a circuit diagram which illustrates the structure of a gate driver incorporated in a display panel as a component of a display drive control system according to the present invention. The gate driver consists of a shift register SFR which includes a plurality of registers SR1, SR2, SR3 and so on. The steps (registers) in this shift register correspond to gate lines G1, G2, G3 and so on, which are shown in FIG. 1.

The shift register SFR receives frame pulse FLM, line clock CL1 and shift clock SFTCLK from the power IC chip PWU. Frame pulse FLM enters terminal Din of the first register SR1; shift clock SFTCLK enters the first shift signal input terminals φ1 of the registers SR1, SR2, SR3 and so on; and line clock CL1 enters their second shift signal input terminals φ2.

This shift register SFR works as explained with reference to FIGS. 3 and 4 so that image signals are sent to source lines of thin film transistors connected with selected gate lines to display an image.

FIG. 13 schematically shows the general structure of a display unit which uses a display drive control system according to the present invention. The display panel PNL is, for example, a liquid crystal display panel which has a liquid crystal layer between two substrates (SUB1, SUB2) to form a display area AR. On the inner surface of the substrate SUB1 are formed many thin film transistors TFT as active elements.

The gate driver circuit GDR is incorporated along one side of the substrate SUB1. The source driver SDR is mounted as an IC chip along another side of the substrate SUB1 by chip-on-glass technology.

At one end of the substrate SUB1 bearing the source driver SDR is a signal connector pad on which a flexible printed circuit board FPC lies to give various signals and voltages from the host computer.

The power IC chip PWU and external components DE are mounted on the flexible printed circuit board FPC and a connector CT for connection with the host computer is located on the opposite side of the LCD panel.

Signals are transmitted and power is supplied between the source driver SDR, flexible printed circuit board FPC and gate driver GDR, through wires formed on the substrate SUB1.

Unlike the structure shown in FIG. 13, the source driver SDR may be mounted on a flexible printed circuit board FPR and the gate driver GDR may be mounted as an IC chip on the substrate SUB1 by chip-on-glass technology or on the flexible printed circuit board FPC.

In the above explanation, it is assumed that the display unit uses low-temperature polysilicon thin film transistors TFT as active elements of its display panel and active elements of related circuits. However, the present invention is not limited thereto and amorphous silicon thin film transistors TFT (known art) may be used instead.

According to the present invention, cost reduction can be achieved by taking full advantage of a source driver IC chip manufactured with a low-voltage (fine wiring) process and a power IC chip manufactured with a high-voltage process. The display drive control systems according to the above embodiments of the present invention may be applied not only to LCD panels but also to other types of display panels in organic EL display units, plasma display units and field emission display units. Furthermore, the present invention is not limited to the abovementioned embodiments or what is claimed herein. It may be embodied in various modified forms without departing from the technical idea of the invention.

1. A display drive control system of a display unit which comprises a display panel with an active matrix of pixels and scanning signal lines and image signal lines for selecting the pixels, a driver circuit for selecting individual pixels of the display panel, and a power circuit for supplying operating voltage to the display panel and the driver circuit,
the driver circuit including a scanning line driver circuit which supplies scanning signals to the scanning signal lines and an image signal line driver circuit which supplies image signals to the image signal lines;
the image signal line driver circuit including a timing signal generator which generates timing signals to control display timings for the display panel; and
the power circuit including a voltage level shift circuit which shifts the voltage level of timing signals generated by the timing signal generator and applies resulting voltage to the scanning line driver circuit,
wherein the power circuit and the voltage level shift circuit are mounted over a semiconductor chip.

2. The display drive control system according to claim 1, wherein the image signal line driver circuit and the timing signal generator are mounted over a semiconductor chip to make up a signal line driver circuit chip.

3. (cancelled)

4. The display drive control system according to claim 2, wherein the scanning line driver circuit is directly formed on the display panel substrate.

5. The display drive control system according to claim 4, wherein the signal line driver circuit chip is directly mounted on the display panel substrate.

6. The display drive control system according to claim 5, wherein the scanning line driver circuit is a shift register.

7. The display drive control system according to claim 6, wherein scanning line control signals supplied from the power circuit chip to the scanning line driver circuit are frame pulse, line clock and shift clock.

8. A display drive control system of a display unit which comprises a display panel with an active matrix of pixels and scanning signal lines and image signal lines for selecting the pixels, a driver circuit for selecting individual pixels of the display panel, and a power circuit for supplying operating voltage to the display panel and the driver circuit,
the driver circuit including:
a scanning line driver circuit which supplies scanning signals to the scanning signal lines and
an image signal line driver circuit which supplies image signals to the image signal lines; and
the power circuit including:
a timing signal generator which generates timing signals to control display timings for the display panel and
a voltage level shift circuit which shifts the voltage level of timing signals generated by the timing signal generator and applies resulting voltage to the scanning line driver circuit,
wherein the power circuit, the timing signal generator, and the voltage level shift circuit are mounted over a semiconductor chip to make up a power control circuit chip.

9. The display drive control system according to claim 8, wherein the image signal line driver circuit is mounted over the same semiconductor chip to make up a signal line driver circuit chip.

10. (cancelled)

11. The display drive control system according to claim 9, wherein the scanning line driver circuit is directly formed on the display panel substrate.

12. The display drive control system according to claim 11, wherein the signal line driver circuit chip is directly mounted on the display panel substrate.

13. The display drive control system according to claim 12, wherein the scanning line driver circuit is a shift register.

14. The display drive control system according to claim 13, wherein scanning line control signals supplied from the power control circuit chip to the scanning line driver circuit are frame pulse, line clock and shift clock.

15. A display drive control system comprising:
a substrate including:
a liquid crystal display area with an active matrix of plural pixels and plural scanning signal lines and plural image signal lines for selecting plural pixels from the plural pixels, and
a scanning line driver circuit which supplies scanning signals to the plural scanning signal lines of the liquid crystal display area;
a first semiconductor chip including:
an image signal line driver circuit which supplies image signals to the image signal lines, and
a timing signal generator which generates timing signals to control display timings for the liquid crystal display area; and
a second semiconductor chip including:
a power circuit which supplies operating voltage for the scanning line driver circuit and tone voltage generation power for generation of tone voltage to be supplied to the plural image signal lines for the first semiconductor chip, and
a level shift circuit which shifts the voltage level of the timing signals supplied from the timing signal generator and supplies resulting voltage to the scanning line driver circuit.

16. The display drive control system according to claim 15, wherein each pixel is comprised of a low-temperature polysilicon thin film transistor as an active element.

17. The display drive control system according to claim 15, wherein the scanning line driver circuit is formed over the substrate with the same process as the thin film transistors are.

18. The display drive control system according to claim 15, wherein the withstand voltage of MOS transistors formed over the first semiconductor chip is lower than that of MOS transistors formed over the second semiconductor chip.

19. The display drive control system according to claim 15, wherein the gate of MOS transistors formed over the first semiconductor chip is shorter than that of MOS transistors formed over the second semiconductor chip.

20. The display drive control system according to claim 15, wherein the timing signals to be level-shifted by the level shift circuit include frame pulse, line clock and shift clock.

21. The display drive control system according to claim 15, wherein the image signal line driver circuit supplies red, green, and blue color image signals to the plural image signal lines of the liquid crystal display area on a time division basis.
